(19) United States
(12) Patent Application Publication
(10) Pub. No.: US 2026/0115996 A1
(43) Pub. Date: Apr. 30, 2026

(54) Method for film production with laser engraving as predetermined breaking point

(71) Applicant: LANG LASER-SYSTEM GMBH, Ummendorf (DE)

(72) Inventors: Bernhard LANG, Ummendorf (DE); Christian LANG, Ummendorf (DE)

(21) Appl. No.: 19/479,066

(22) PCT Filed: Apr. 4, 2024
(86) PCT No.: PCT/EP2024/059130

§ 371 Date: Oct. 27, 2025

(30) Foreign Application Priority Data
Jul. 28, 2023 (DE) 10 2023 120 213.8

(51) Int. Cl. B29C 59/00; B23K 26/064; B23K 26/402; B29L 31/00

(52) U.S. Cl. CPC B29C 59/007; B23K 26/0643; B23K 26/402; B29C 2791/009; B29L 2031/7164; B29L 2031/7174

(57) ABSTRACT

A method for producing a film as part of a packaging container in order to at least partially delimit an interior of the packaging container. The film is designed to tear at a predetermined breaking point as a result of mechanical pressure, in order to provide access to the interior. The method includes: providing the film as a monofilm or film composite with at least one layer, in which at least the outer and/or inner layer with respect to the interior is made of plastic, producing a predetermined breaking point in the form of a laser engraving by removing part of the film by means of a laser, wherein the removal is by way of a local reduction of the film thickness by the laser and thus the predetermined breaking point is designed as a laser engraving.

### CROSS-REFERENCE TO RELATED APPLICATIONS

This Application is a Section 371 National Stage Application of International Application No. PCT/EP2024/059130, filed Apr. 4, 2024, and published as WO 2025/026587 A1 on Feb. 6, 2025, not in English, which claims priority to and the benefit of German Patent Application No. 10 2023 120 213.8, filed Jul. 28, 2023, the contents of which are incorporated herein by reference in their entireties.

### FILED OF THE DISCLOSURE

The present disclosure relates to a method for producing a film as part of a packaging container for at least partly delimiting an interior of the packaging container, the film being designed to tear at a predetermined breaking point by mechanical pressure in order to thus release access to the interior. Further proposed are a film and a packaging container.

### BACKGROUND

Various blister-type packaging containers are known from the prior art, such as tablet packs in the form of push-through packs and coffee capsules for the preparation of hot coffee beverages. Such tablet packs to date traditionally have an aluminum film as a lidding film on a thermoformed part. Modern tablet packs are meant to be more sustainable. That is why they now avoid using aluminum and use plastic only. Whereas some coffee capsules are also traditionally made of aluminum, attempts are now being made to use recycled material, for instance plastic, as described in EP 4 173 978 A1 for example, and/or a compostable material, as proposed in EP 3 847 014 A1 for example, for more environmentally friendly products. This is because the capsule is a typical disposable item and is discarded after single use. However, it has been found that manufacture is generally more cost-intensive when using such an alternative to aluminum.

In EP 3 362 377 B1 as prior art, a capsule has been disclosed for the preparation of beverages and a method for producing said capsule where a part of the cover film is weakened using a laser beam.

### SUMMARY

An exemplary aspect of the present disclosure relates to a method of producing a film as part of a packaging container for at least partly delimiting an interior of the packaging container, the film being designed to tear at a predetermined breaking point by mechanical pressure in order to thus release access to the interior. The method includes: providing the film as a monofilm or composite film having at least one layer, in which at least an outer and/or inner layer in relation to the interior is made of plastic; and generating the predetermined breaking point in the form of a laser engraving by ablation of part of the film by using a laser, the ablation being carried out by the laser as a local reduction in film thickness and the predetermined breaking point thus being in the form of the laser engraving (4). An ultraviolet (UV) laser is used as the laser in order to perform cold ablation without formation of melted edges in an edge region of the laser engraving, so that the laser engraving is formed in the film without completely passing through the monofilm or the composite film, and is, in a section through the film perpendicular to a course thereof, formed like a wedge or blind hole that ends in one of the at least one layer of the film.

An exemplary aspect of the present disclosure proposes a film and a method of production for a corresponding film that can eliminate the disadvantages of the prior art and that allow, in particular, more cost-effective manufacture without loss of quality.

Proceeding from a film and a method of production of the type mentioned at the beginning, this exemplary object is achieved by the characteristic features of the independent claims.

The measures specified in the dependent claims allow advantageous embodiments and developments of aspects of the disclosure.

Stored in a packaging container according to as aspect of the disclosure, such as a coffee capsule, is coffee powder or a powder for beverage preparation. To this end, the coffee capsule has an interior. Preparation in itself is generally achieved by flushing the interior, such that hot water comes into the interior and thus into contact with the powder. To establish access to the interior, it is necessary to open or break open the capsule. Provided for this purpose is a film which at least partly delimits the interior of the capsule. Said film can generally be used as a lidding film of the capsule. A film can be pierced more easily than, for example, a relatively thick plastics tub, in the case of blisters for instance.

A tablet pack according to an aspect of the disclosure may be, for example, a push-through pack. Fingers are used to apply pressure to the thermoformed part. The force is transmitted to the tablet and, in turn, to the film that is to tear open, such that the tablet passes out of the interior.

Originally, use was especially made of aluminum films, as used in general for packing and storing food. However, aluminum production is not particularly environmentally friendly.

In the case of the coffee capsule, film breaking can traditionally also be mechanically achieved by means of a spike that drills into the film. However, there is the risk, especially in the case of plastics films and plastics capsules, that film particles or film residues will detach and pass into the beverage, which is to be avoided for various reasons (for reasons of health, quality and hygiene). However, the breaking properties of plastics films are usually worse than those of an aluminum film. Traditional tablet push-through packs made of plastic are also generally much more difficult to open, requiring more force to open, than those having an aluminum lidding film. In addition, if a plastics film is also accompanied by an additional barrier layer, the breaking properties are often not comparable to those of an aluminum film, and so it is doubtful whether such a plastics film is suitable for producing packaging. Mechanical breaking of plastics films, for example monofilms or recycled films, can also be achieved by high pressure from the steam acting on the capsule. But here as well, there is the risk of detachment of film particles or film residues. Traditional tablet push-through packs also have the same risk.

In order to be able to improve the breaking properties of a plastics film as an alternative film, it can be notched with very fine tracks by means of a roller stamping die. However, the inventors have recognized that this technique is associated with high costs, since it is complex and entails high tool costs, since not only must the roller stamping die be produced, but, as a tool, it also wears out quickly. Furthermore, temperature influences cause expansion problems. Production measures are inflexible, and a new stamping die may have to be produced every time an adjustment is made. Requirements concerning lasting quality cannot be met.

An aspect of the disclosure is therefore distinguished by the creation of a predetermined breaking point which breaks under mechanical pressure at a defined point in the film. Said predetermined breaking point is generated as a laser engraving, which makes a mechanical stamping die, for example, obsolete.

Mechanical tool wear is thus basically completely avoided.

A laser engraving according to an aspect of the disclosure, however, also offers further advantages:
There is no need for complex and costly manufacture of a new tool in the event of a change, for example, to the capsule product to be produced, i.e., in the event of, for example, a change to the shape/contour of the predetermined breaking point or to the depth or track width of the predetermined breaking point. Instead, it is generally sufficient to reprogram the control system of the laser.
Even in the event of a change to the capsule material, for example a different plastic, there is generally no need for a different tool, but instead only a change to the control sequence.
The changeover time is thus also considerably much shorter, since only the control system has to be reprogrammed, for example, which can usually be implemented much more quickly the production of a stamping die. This allows a higher production number.

To allow the film to break cleanly and in a geometrically defined manner, the laser engraving may be in the form of a line. In principle, it is conceivable to also provide weak spots in the material by means of point-like recesses. Especially when opening the capsule by mechanical pressure, in particular by steam, in the region of the predetermined breaking point, i.e., when, for example, flushing the interior of the capsule with hot water to prepare a beverage, the passing of film residues or film particles into the water and thus subsequently into the beverage is to be avoided if possible. It is therefore advantageous to provide a predetermined breaking point which runs over a relatively long distance, since the film material will otherwise also need to tear open at spots which are not weakened in term of their thickness, which in turn can lead to individual film components tearing open more easily. The more defined the predetermined breaking point that is prepared by the laser engraving, the better the result of beverage preparation may also be in terms of reproducibility and quality.

Likewise, such particles from lidding films are also to be avoided as residues on tablets.

For completely detachment of a surface region, a closed surface region of the film may in principle also be surrounded by the laser engraving. In the case of coffee capsules, however, a continuous surface is generally not to be separated from the film by pressure, since although the capsule is to be opened as a packaging container, it is not to be divided into multiple parts, which could, for example, impede the flow of water.

In one development of the disclosure, the laser engraving is performed as so-called cold ablation. Cold ablation allows, for example, an engraving free of melted edges, thus maintaining the smooth film surface. Any edge thickening can lead, for example, to unwanted deposition of minute dirt particles. It can also lead to sealing problems or the like and is therefore a rather disruptive artefact. Such cold ablation may be achieved, for example, by way of a laser emitting in the ultraviolet range, for instance at a wavelength of 355 nm. In contrast, a CO2 laser leads to material ablation with a melted edge.

To be environmentally friendly, the film and accordingly the packaging container as well, for instance the tablet pack or the coffee capsule, may be aluminum-free. A recyclable material may be used instead. In principle, compostable materials are also conceivable. Plastic, for example, can generally be easily recycled. In some cases, some plastics can also be composted. To open a film at the predetermined breaking point by the steam pressure generated in the coffee machine or coffee maker, it may be advantageous for the film to be as thin as possible, for example in the form of a single-layer monofilm. However, it is also conceivable to use composite materials, which allow more defined properties as a composition of different material functionalities. One layer, in particular the outer layer on the surface, may be in the form of a plastics layer that is also provided with the laser engraving. It is also conceivable that at least two layers or all layers are made of plastic.

To protect the food or pharmaceutical product stored in the interior, one of the layers may be, for example, in the form of a barrier layer, for example in the form of an EVOH layer (EVOH: a copolymer of ethylene and vinyl alcohol, which is prepared from the polymerization of ethylene and vinyl acetate). The barrier layer may also be included by the laser engraving in order to generate a predetermined breaking point. In the case of use of barrier layers, it was previously hardly possible in the prior art to achieve the required breaking properties of a predetermined breaking point if only stamping dies were used for weakening materials.

The track depth includes one layer without completely passing through it or includes multiple layers. This laser engraving, in a section through the film perpendicular to the course thereof, looks like a wedge or blind hole that ends in one of the film layers. The film layer or film layers above it, if the film is not a monofilm, are then completely passed through. In the case of composite materials, it may be the case that the laser engraving has to include more than one layer in order to allow the film to be opened.

Owing to its high tensile strength, biaxially oriented PET film (BOPET, where PET stands for: polyethylene terephthalate) is moreover also highly suitable for hermetically sealed food packs.

The film thickness may in general be, for example, between 15 μm and 50 μm.

To achieve a good compromise between the strength of the predetermined breaking point and the openability thereof, the depth of ablation may range from 5 μm to 30 μm, while the track width varies approximately between 15 μm and 50 μm, depending on the embodiment.

In one embodiment of the disclosure, an advantageous embodiment is the capsule in the form of a blister. It comprises a molded plastics part or thermoformed part, the shape of which defines the interior. It has an opening to which a film can be applied and attached or sealed. The film is generally thinner and weaker than the thermoformed part, such that the predetermined breaking point can also be integrated into the film. The blister can be transported comparatively securely.

Accordingly, a method of production according to an aspect of the disclosure is distinguished by the generation of a predetermined breaking point in the form of a laser engraving by ablation of part of the film by means of a laser, the ablation being carried out as a local reduction in film thickness and being carried out by a laser, such that the predetermined breaking point is in the form of a laser engraving. Use can be made here of the advantages already explained in connection with the coffee capsule. More environmentally friendly capsules free of aluminum can be produced without mechanical tools and can instead be produced with an optical tool, a laser for generating a laser engraving. This can save costs and shorten production times. Moreover, material can be saved, since the construction of new tools due to wear or product change is not necessary. Temperature influences and the like are less important. The films or packs to be produced have a lower scrap rate.

In one development of the disclosure, the geometry of the laser engraving is achieved by way of a mirror deflection system or a scanner. By programming the corresponding control system used to orient the mirrors, it is possible to direct the laser beam and thus generate a wide variety of geometries.

Alternatively, it is also conceivable for the laser to be left stationary and, instead, for the film to be moved relative to the laser beam by way of a positioning system in order to obtain the desired geometry.

Reticular line structures may be realised, as may parallel lines. Line spacing may thus also be varied. In the regions in which lines would overlap, a point without overlaps may also be produced by interrupting the laser beam that would otherwise be incident there. The laser may also be temporarily switched off there. These measures make it possible set the pressure or force at which the expected tearing of the film will occur at the predetermined breaking point.

An aspect of the disclosure also proposes a coffee capsule which has undergone ablation to yield an engraving line or track without a melted edge, such that the engraving can be present in an outer plastics layer.

In the case of some packaging containers, especially in the case of a tablet pack in the form of a push-through pack, the film may also be arranged in such a way that the laser engraving is in the interior, from where the force also acts on the film. Such an arrangement is also conceivable in principle for coffee capsules.

### BRIEF DESCRIPTION OF THE DREAWINGS

Exemplary embodiments of the disclosure are shown in the drawings and will be explained in greater detail in the following with specification of further details and advantages.

Specifically, the drawings show:

FIG. 1: a schematic section through a film according to an aspect of the disclosure,

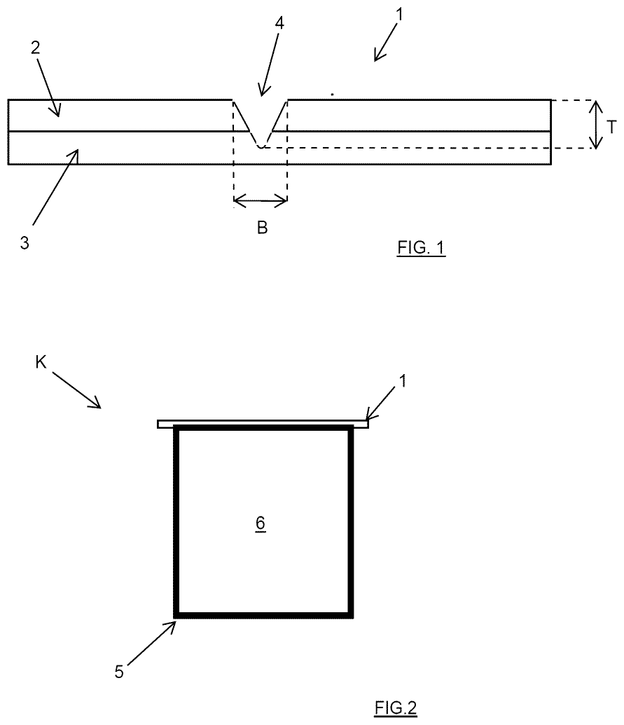

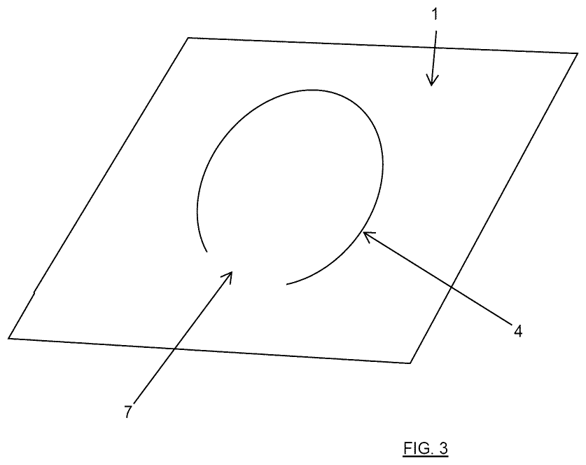

FIG. 2: a schematic section through a coffee capsule according to an aspect of the disclosure,

FIG. 3: a schematic illustration of a laser engraving according to an aspect of the disclosure, and

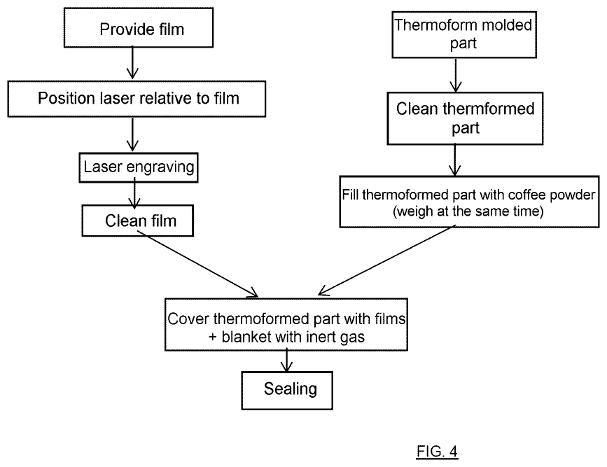

FIG. 4: a schematic illustration of method of production for a coffee capsule according to an aspect of the disclosure.

### DETAILED DESCRIPTION OF ILLUSTRATIVE EMBODIMENTS

FIG. 1 shows a schematic section through a film 1 composed of two layers 2, 3. The two layers 2, 3 are made of plastic. Incorporated in the film 1 is laser engraving 4 which, in turn, has a track width B and a depth T. The laser engraving 4 forms the predetermined breaking point in the film 1 and the depth thereof completely penetrates the outer layer 2 (here in FIG. 1: the top layer 2). However, the laser engraving 4 also partly includes the bottom layer 3. The thickness of the film 1 is thus locally reduced in the region of the laser engraving 4. As can be seen at the sides of the laser engraving 4, there are no melted edges at both sides of the laser engraving 4. In this case, the predetermined breaking point or laser engraving 4 is wedge-shaped. Compared to a wider, trough-like shape, this offers the advantage of the point being able to break more easily when acted on by pressure.

FIG. 2 shows a schematic section through a coffee capsule K in the form of a blister. It consists of a pot-like thermoformed part 5 made of a plastic thicker than of the film 1, in the form of a lidding film which covers the thermoformed part 5. Present inside the thermoformed part 5, the top of which is delimited by the covering film 1, is the interior 6 of the coffee capsule K filled with coffee powder. The film 1 is sealed on the edge of the thermoformed part 5.

In FIG. 3, a predetermined breaking point comprising a laser engraving 4 can be seen on a film 1. It is round, and the track 4 is interrupted at one point, so that the material does not pass into the coffee during brewing, i.e., the lid in the middle of the predetermined breaking point continues to remain connected to the film 1.

FIG. 4 outlines a method of production:
The film can be provided.
The laser is positioned relative to the film by way of a scanner.
This is followed by laser engraving, the laser still traveling the predetermined engraving line by means of the scanner.
Optionally, the film can be cleaned or sterilized, for example by gentle blowing with a gas.

At the same time, one type of blister can be generated. This is achieved by carrying out the following steps:

### Thermoforming a Molded Part.

Cleaning the thermoformed part, for example by blowing.
Filling the molded part with coffee powder. Optionally, this is done under an inert gas, so that the coffee powder keeps for longer in the capsule K and does not lose its flavor. Weighing is carried out during filling, or filling is carried out with pre-portioned amounts of powder.

Both the thermoformed part 5 and the film 1 form the finished capsule K. The film 1 and the thermoformed part 5 must be joined to each other, in this case sealed, so that ambient air does not reach the coffee powder stored in the interior 6 and cause damage to it or its flavor.

Common to all the exemplary embodiments and developments of the disclosure is that a predetermined breaking point is generated in order to tear at the predetermined breaking point by mechanical pressure and to release access to the interior, at least the outer or inner layer in relation to the interior being made of plastic;

they are distinguished by the predetermined breaking point being in the form of a laser engraving in which the film thickness has been locally reduced by ablation by means of a laser.

### LIST OF REFERENCE SIGNS

1 film
2 outer plastics layer
3 additional layer
4 laser engraving
5 thermoformed part
6 interior of the capsule
7 interruption in the engraving
B track width
K coffee capsule
T track depth

1. A method comprising:
producing a film as part of a packaging container for at least partly delimiting an interior of the packaging container, the film being designed to tear at a predetermined breaking point by mechanical pressure in order to thus release access to the interior, the method comprising:
providing the film as a monofilm or composite film having at least one layer, in which at least an outer and/or inner layer in relation to the interior is made of plastic; and
generating the predetermined breaking point in the form of a laser engraving by ablation of part of the film by using a laser, the ablation being carried out by the laser as a local reduction in film thickness and the predetermined breaking point thus being in the form of the laser engraving,
wherein a ultraviolet (UV) laser is used as the laser in order to perform cold ablation without formation of melted edges in an edge region of the laser engraving, so that the laser engraving is formed in the film without completely passing through the monofilm or the composite film, and is, in a section through the film perpendicular to a course thereof, formed like a wedge or blind hole that ends in one of the at least one layer of the film.

2. (canceled)

3. The method as claimed in claim 1, wherein the laser has a laser beam used for ablation and/or production of the laser engraving which:
is positioned relative to the film by way of a mirror deflection system, and/or remains stationary, while the film is moved relative to the laser beam.

4. The method as claimed in the film comprises the following material:
a film of 15 micrometers (μm) to 50 μm in thickness and/or
a 2-layer biaxially oriented polyethylene terephthalate (BOPET) film.

5. The method as claimed in claim 1, wherein the ablation comprises generating the laser engraving from 15 μm to 50 μm in track width.

6. The method as claimed in claim 1, wherein the ablation comprises generating the laser engraving with a track width from 15 μm to 50 μm in and/or with a laser engraving depth from 5 μm to 30 μm.

7. The method as claimed in claim 1, wherein the predetermined breaking point has a breaking behavior set by:
ablating a reticular line structure as the laser engraving and/or
ablating at least two parallel lines as the laser engraving and/or
varying a line spacing of a plurality of laser engravings during ablation.

8. The method as claimed in claim 1, further comprising ablating at least one point-like structure in addition to at least one line formed by the laser engraving.

9. The method as claimed claim 1, comprising producing intersecting lines without overlap as the laser engraving, by interrupting a laser beam of the laser in a region where the lines overlap and/or switching off the laser in said region.

10. The method as claimed in claim 1, comprising:
producing the packaging container such that a molded plastics part forming an interior is shaped and is at least partly covered by and joined to the film as a rear wall in order to at least partly delimit the interior.

11. (canceled)

12. A film for at least partial delimitation of an interior of a packaging container, the film comprising:
a monofilm or composite film having at least one layer; and
a predetermined breaking point in order to tear at the predetermined breaking point by mechanical pressure in order to thus release access to the interior, the monofilm or at least one of an outer or inner layer of the composite film being made of plastic,
wherein the predetermined breaking point is in the form of a laser engraving in which a thickness of the film has been locally reduced by ablation by use of a laser, wherein the laser engraving is delimited without a melted edge and thus without local thickening of the film at the edge of track of the laser engraving, where the laser engraving is formed in the film without completely passing through the monofilm or the composite film, and is, in a section through the film perpendicular to a course thereof, formed like a wedge or blind hole that ends in one of the at least one layer of the film.

13. The film as claimed in claim 12, wherein the laser engraving is in the form of a line and/or surrounds a closed surface region on the film.

14. (canceled)

15. The film as claimed in claim 12, wherein the monofilm and/or all the layers of the composite film is/are:
made of plastic and/or
made of a recyclable material and/or
aluminum-free.

16. The film as claimed in claim 12, comprising at least one ethylene vinyl alcohol (EVOH) barrier layer.

17. The film as claimed in claim 12, wherein the ablation of the laser engraving is formed in all layers of the film.

18. The film as claimed in claim 1, wherein the film:
has a thickness of 15 micrometers (μm) to 50 μm and/or
is in the form of a 2-layer biaxially oriented polyethylene terephthalate (BOPET) film.

19. The film as claimed in claim 1, wherein the laser engraving, due to the ablation, has a depth from 5 μm to 30 μm and/or a track width from μm to 50 μm.

20. A packaging container comprising the film as claimed in claim 12.

21. The packaging container as claimed in claim 20, wherein the packaging container is in the form of a:
coffee capsule and/or
tablet pack and/or
push-through pack and/or
blister pack and/or
blister comprising a plastics molded part for forming the interior and the film as a rear wall of the plastics molded part.
